(19) United States
(12) Patent Application Publication
(10) Pub. No.: US 2026/0149913 A1
(43) Pub. Date: May 28, 2026

(54) TRUE WIRELESS STEREO EARPHONE ASSEMBLY HAVING TES TREATMENT FUNCTION

(71) Applicant: MOBIFREN CO., LTD, GUMI-SI (KR)

(72) Inventor: JU WON HEO, GUMI-SI (KR)

(21) Appl. No.: 18/962,720

(22) Filed: Nov. 27, 2024

(51) Int. Cl. H04R 1/10; H04R 1/1025; H04R 5/033

(52) U.S. Cl. CPC H04R 1/1091; H04R 1/1025; H04R 1/1033; H04R 5/033; H04R 2420/07

(57) ABSTRACT

The present disclosure relates to a true wireless stereo (TWS) earphone assembly having a TES treatment function.

### BACKGROUND OF THE INVENTION

### 1. Field of the invention

The present disclosure relates to a true wireless stereo (TWS) earphone assembly having a transcranial electrical stimulation (TES) treatment function. More specifically, the present disclosure provides a TWS earphone assembly configured to perform not only listening according to transmission of an acoustic signal but also an electrical TES treatment function according to the user’s choice in a TWS earphone that has a pair of electrically separated left and right earphones and transmits signals according to the Bluetooth protocol, and an improvement in the configuration thereof.

### 2. Description of the Prior Art

Recently, TWS earphones based on signal transmission according to the Bluetooth protocol have become a standard sound listening means.

TWS earphones are equipped with a pair of left and right earphones as electrically separated sound units, and do not require separate electrical connections between the earphones, and receive and play sound from an audio device using Bluetooth communication protocol.

The present disclosure has been made to provide further improved functions to TWS earphones that can selectively perform TES treatment functions.

(1) From a mental health perspective, problems such as insomnia, depression, ADHD, neurasthenia, decreased concentration, and fatigue are becoming serious problems for modern people. In particular, in Russia and Northern Europe, where the winter season is long, there have been many efforts and attempts to improve symptoms of mental health pathologies due to climate by applying electrical or magnetic stimulation to the human body.

Recently, the treatment technique using “transcranial micro-electrical stimulation” or “transcranial magnetic stimulation” called transcranial magnetic stimulation) (TMS) or transcranial electrical stimulation (TES) has been proven theoretically and experimentally through numerous papers and clinical trials to be significantly effective, and TMS and TES stimulation devices have already been widely distributed in many domestic psychiatric hospitals and youth mental health hospitals.

(2) In particular, TES treatment has been actively introduced and its distribution is rapidly expanding due to its non-pharmacological, non-invasive, non-addictive characteristics, and extremely low risk of medical accidents.

(3) Conventionally, a TES or TMS device for treating mental health pathologies has been installed on a chair where the patient sits and receives treatment. The TES or TMS device as a single device is equipped with multiple electrode attachment pads, electrical stimulation circuits, and micro-adjustment panels, making it very expensive and available only to mid- to large-sized hospitals.

Considering these points, the inventor of the present disclosure considered that it was technically possible to apply the TES treatment function to headsets, earphones, or the like, and has developed a number of suitable technologies for this purpose.

In particular, the technology for providing TES treatment function to earphones and headsets and distributing them to the general public in a form that is easy to carry is disclosed in Korean Patent No. 2194226 (entitled “Bone Conduction Device with TES Treatment Function”) in the name of the assignee of the present application, and the technical idea for applying this function of the prior application to TWS earphones is disclosed in Korean Patent Application No. 10-2023-0191707 (entitled “TWS Earphone Assembly with TES Treatment Function”) filed in the name of the assignee of the present application on December 26, 2023.

In the above prior application, a link cable essential for transmitting a TES signal through the human body to a pair of left and right earphones is provided, in which, when the TES treatment function is performed, the link cable is connected, and when entering the sound listening mode, the link cable is removed from the earphones, thereby enabling the TES treatment function to be selectively provided.

The configurations of the prior application may be very easy and convenient to use. However, since the connection terminals between the link cables and the earphones only have the function of transmitting TES signals, a pair of separate contact terminals for charging is required in the earphone housing in order to charge the earphone unit itself.

In addition, from a design perspective, there was a problem in that the size of both earphones may increase because a TES signal generator was configured on the receiving circuit board of either the left or right earphone and the sizes of the right and left earphones had to be the same.

Accordingly, not only does the size of the earphones become larger, but the circuit board for operation, the terminal pins for charging, and the wiring or board contact circuit for connection between these parts are required within the very narrow space of the earphone bodies, making the configuration complex, increasing the manufacturing cost, and also raising the risk of failure due to repeated user use.

### Prior Art Documents

### Patent Documents

(Patent Document 0001) Korean Patent No. 2194266 (December 16, 2020)

(Patent Document 0002) U.S. Patent No. 9,686,603 (June 20, 2017)

(Patent Document 0003) U.S. Patent Application Publication No. 2009/0185699 (July 23, 2009)

(Patent Document 0004) U.S. Patent Application Publication No. 2015/0382115 (December 31, 2015)

(Patent Document 0005) U.S. Patent Application Publication No. 2017/0368329 (December 28, 2017)

### SUMMARY OF THE INVENTION

Therefore, a compact and versatile design of the earphone housing is required for the electrical circuit configuration.

Furthermore, a TWS earphone is required that can perform the functions of a terminal for electrical connection of the earphone as both a terminal for transmitting TES signals into the human body and a charging terminal for charging, thereby simplifying the overall configuration, reducing the production cost, and minimizing wear and failure due to frequent terminal contact.

To help understand the present invention, a TWS earphone assembly with a TES treatment function disclosed in the above-mentioned patent and patent application is described with reference to FIGS. 9 and 10.

As illustrated in FIGS. 9 and 10, a circuit accommodated in each the housings H2 and H2’ of a pair of left and right earphones RE2 and LE2 includes a Bluetooth communication module 210, memory 215, a decoder 220, a digital-to-analog converter 225, an audio amplifier 230, a speaker 241 or 242, and a controller 290 operated via a user LS interface 280.

One of the circuits accommodated in the housings H2 and H2’ of the pair of earphones RE2, LE2 further includes, in addition to the above-described sound data reception and playback circuit, a frequency generator 250 that is signal-connected to the controller 290, which is operated and controlled by the user LS interface 280 and generates low-frequency signals to implement the TES treatment function, and a TES signal amplifier 260 that amplifies the generated low-frequency signals.

The TES signal amplifier 260 allows the user LS to vary the degree of amplification through the user LS interface 280, and the frequency generator may be configured as a separate circuit unit as described above, but the controller 290 may directly generate low-frequency signals.

The circuit accommodated in each the housings H2 and H2’ of the pair of left and right earphones RE2 and LE2 includes a Bluetooth communication module 210, memory 215, a decoder 220, a digital-to-analog converter 225, an audio amplifier 230, a speaker 241 or 242, and a controller 290 operated via a user LS interface 280.

The earphones RE2 and LE2 are provided with female connectors FC2 and FC2’), respectively, and a link cable LC1 having male connectors MC2 and MC2’) at both ends for electrically and selectively connecting the pair of female connectors FC2 and FC2’ is provided. Thus transmission of TES signals to the pair of left and right earphones RE2 and LE2 is allowed or blocked by connecting and disconnecting the link cable LC1.

In the case of the above-described configuration, since a separate electrode terminal pin is required for charging the battery (not shown) of each of the earphones RE2 and LE2, the configuration is very complicated. In addition, the frequency generator 250 signal-connected to the TES generation signal controller 290 and the TES signal amplifier 260 that amplifies generated low-frequency signals are formed into an integrated circuit and configured in either the left or right earphone, and the intensity of the TES signals preferred by the user LS who wants to receive TES treatment is controlled through the operation of the user LS interface 250 connected to the controller 290. Therefore, when the user LS wants to adjust the intensity of the TES signals while listening to the sound for relaxation, the volume operation and the operation pattern of the user LS interface 250 overlap, so that the control of the intensity of TES signals may be impossible or be allowed in a limited manner.

In consideration of the above-mentioned problems, the present disclosure aims to provide a TWS assembly capable of selectively performing a TES treatment function with an improved configuration in which the entire circuit is improved, the terminal connection configuration for charging the earphone body battery is unified, and the problems such as the configuration of terminal pins for separate charging, wiring, and enlargement of the earphone body are eliminated.

In view of the foregoing, a TWS earphone assembly includes: an electrode M for electrical connection with a skin of an ear of a user on an outer surface of an ear unit I of each of a pair of electrically separated left and right earphones RE and LE; a circuit accommodated in each of the earphones RE and LE and having a Bluetooth communication module 10, memory 15, a decoder 20, a D/A converter 25, an audio amplifier 30, a speaker 40, and a controller 90 controlled via a user LS interface 80; and a charging cradle R having terminals connected to terminals of the earphones RE and LE to enable charging of the earphones RE and LE.

The TWS earphone assembly further includes: a variable DC/DC converter 100, which is provided in a first circuit C1, which is a separated circuit of one of the pair of separated left and right earphones RE and LE, and connected to the control part 90; a TES signal generator 50, which generates low-frequency signals for treatment, and a variable amplifier 60 configured to amplify the low-frequency signals, wherein the TES signal generator and the variable amplifier are provided in a second circuit C2, which is another one of separated circuits of the pair of separated right and left earphones and connected to the controller 90; and a link cable LC, which is selectively attached to/detached from terminals of the pair of left and right earphones RE and LE to electrically connect or disconnect the earphones RE and LE.

TWS earphone assembly is configured to selectively perform sound playback function as TWS earphones and TES treatment function individually or simultaneously, wherein the sound playback function is executed when the pair of left and right earphones RE and LE are used in a state where the link cable LC is detached therefrom, and wherein the TES treatment function is executed by allowing the low-frequency signals flow between the electrodes M of the earphones RE and LE through the body of the user LS in a state where the terminals of the pair of earphones RE and LE and the link cable LC are attached to the earphones.

The present disclosure can be easily applied to a TWS earphones so that a user (LS) can easily and selectively use the TES treatment function, thereby enjoying sound listening and getting TES treatment.

The TWS earphone assembly having a TES treatment function according to the present disclosure provides the earphones having a terminal connection configuration that enables the terminal connection of the charging cradle and the terminal connection of the link cable to be performed simultaneously, and provides an improved circuit that can control such connection, thereby providing simplicity in product configuration and operational reliability.

Additional accommodation spaces for earphones are further provided, so that loss of the link cable can be suppressed.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is an external perspective view showing only a pair of left and right earphones of a TWS earphone assembly having a TES treatment function according to the present disclosure;

FIG. 2 is an exemplary external perspective view showing the configuration and use of the TWS earphone assembly and a charging cradle;

FIG. 3 is an exemplary external perspective view showing the configuration and use of only a charging cradle in the TWS earphone assembly;

FIG. 4 is a block diagram of the entire circuit configuration of the TWS earphone assembly;

FIG. 5 is an explanatory view illustrating a wiring relationship for connecting a link cable between terminals for TES treatment;

FIG. 6 is an explanatory view illustrating a wiring relationship between a pair of terminals of the TWS earphone assembly and terminals of the charging cradle in a charging state;

FIG. 7 is an explanatory view illustrating voltage intensity control of TES signals when using the TES treatment function of the earphone assembly;

FIG. 8 is an exemplary circuit configuration diagram in the case where the circuit part of the TWS earphone assembly having the TES treatment function according to the present disclosure is actually configured;

FIG. 9 is an external perspective view illustrating a single TWS earphone assembly having a TES treatment function of an embodiment of the prior application of the inventor of the present disclosure; and

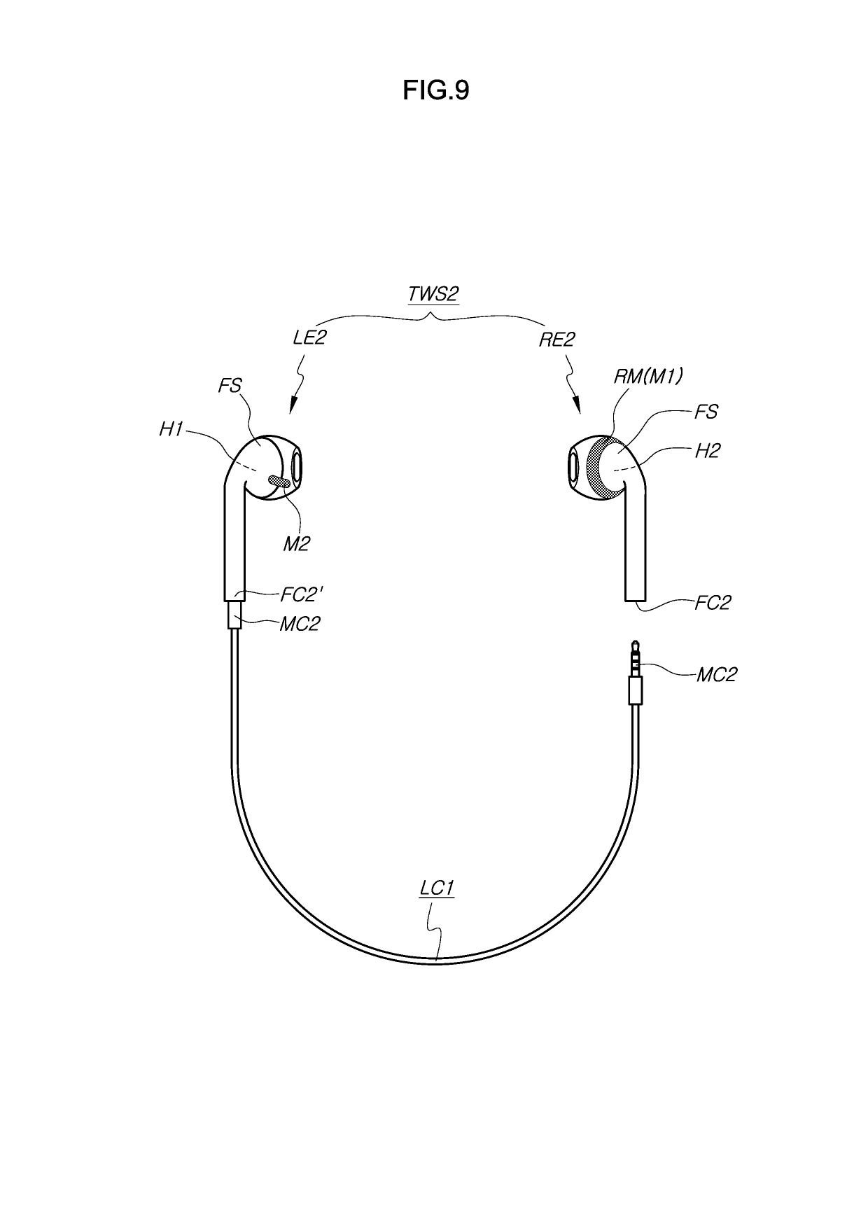

FIG. 10 is a circuit configuration diagram of an embodiment of the prior application of FIG. 9.

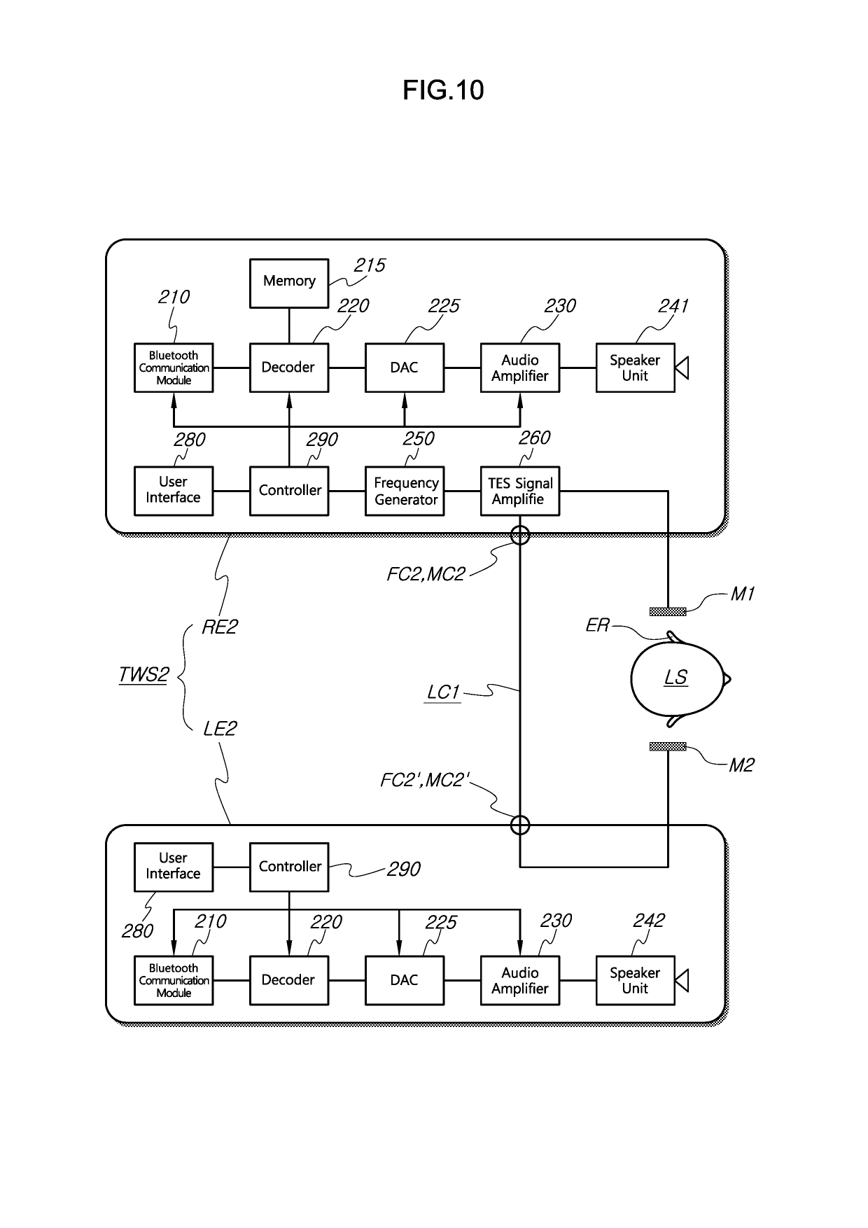

### DETAILED DESCRIPTION OF THE EXEMPLARY EMBODIMENTS

Hereinafter, the present disclosure will be described in detail with reference to the attached drawings.

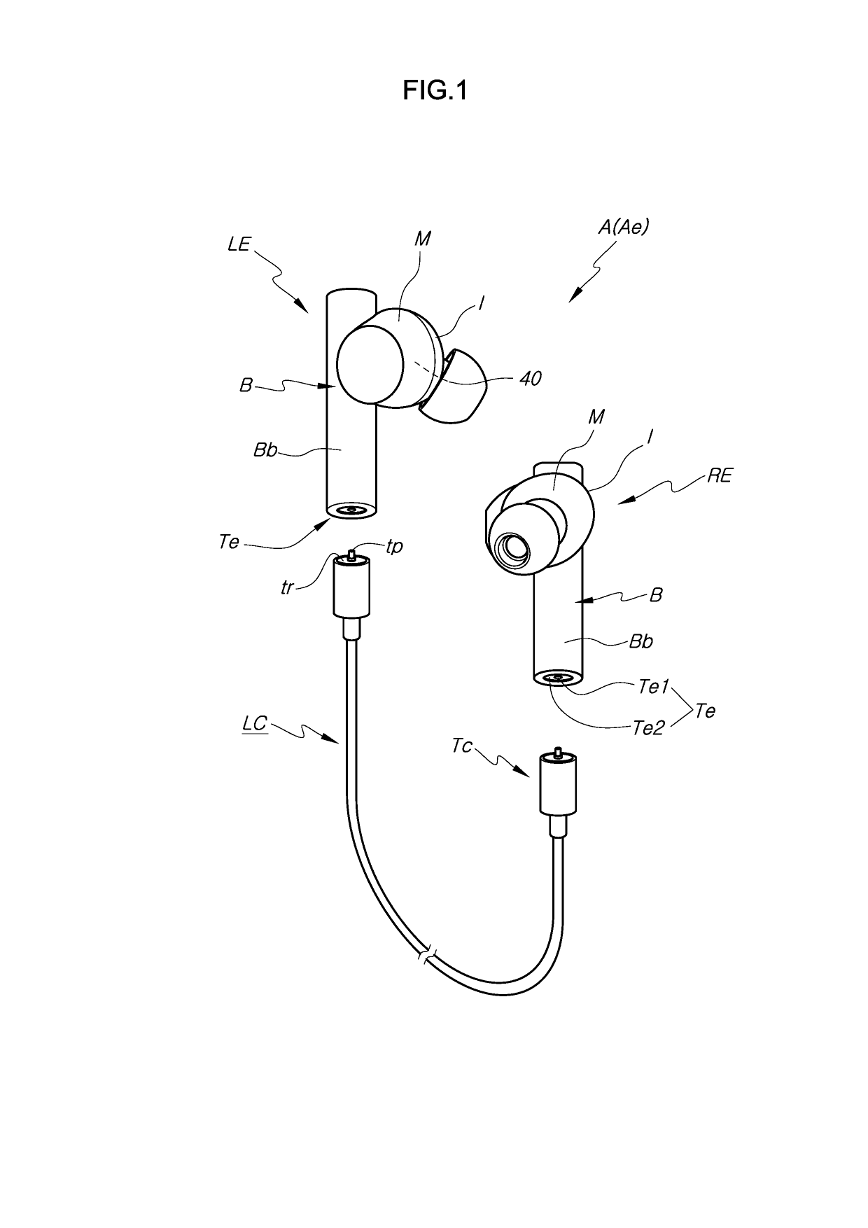

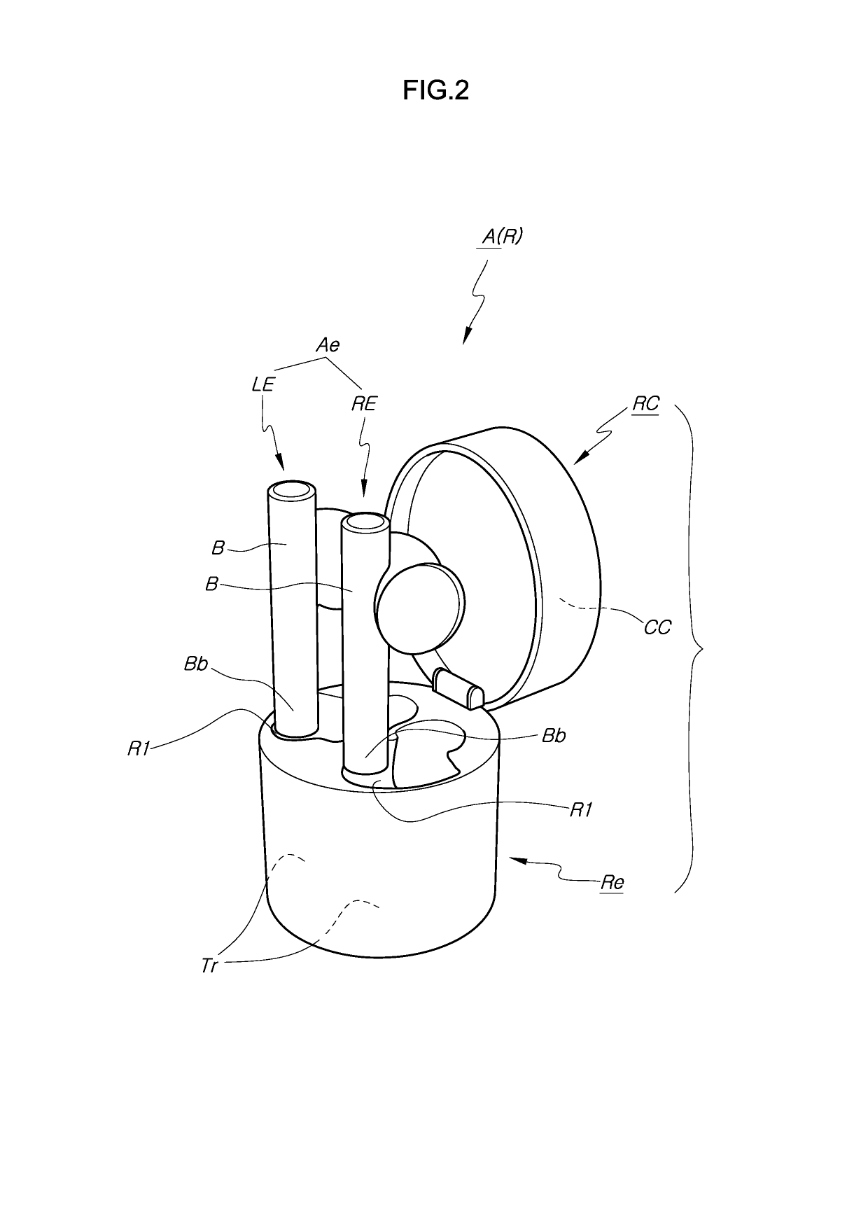

FIG. 1 is an external perspective view showing an earphone unit Ae including a pair of left and right earphones RE and LE of a TWS earphone assembly A, and FIG. 2 is an exemplary external perspective view showing a state in which the earphone assembly is inserted into a charging cradle.

Since the left and right earphones form a symmetrical pair, reference numerals are assigned to only one of them, and the same reference numerals are used for the same components of the earphones.

The TWS earphone assembly A including the right and left earphones RE and LE and having a TES treatment function according to the present disclosure may be made in various shapes and designs.

The body housings B of the earphones RE and LE are a long bar-shaped cylindrical bodies that each accommodates a circuit and a rechargeable battery (not illustrated), and speakers 40 for listening to sound are accommodated in ear units I connected to the body housings B, respectively.

Electrodes M covered or partially exposed with various conductive metals, conductive rubber, or conductive plastic are provided on the outer peripheral portions of the ear units I to be inserted into the ears of the user LS, and the positions and shapes of the electrodes M are determined so that TES signals are optimally transmitted to the human body by properly bringing the electrodes M into close contact with the inner ears of the user LS.

Each body bar Bb extending downward from the earphone unit of a body housing B is a long bar shape suitable for insertion into a charging slot R1 of the charging cradle R as illustrated in FIG. 2.

At the end of the body bar Bb, an earphone terminal Te is provided as a conductive electrode body, and the earphone terminal Te as a terminal is made of a conductive magnet material such as neodymium material having a considerable degree of magnetic force, so that it is convenient to perform a connection by being detached by magnetic force and to maintain the connection by a strong magnetic force during use.

Each earphone terminal Te has a contact piece Te1 in the center and a ring-shaped contact piece Te2 in the outer periphery, which are electrically separated.

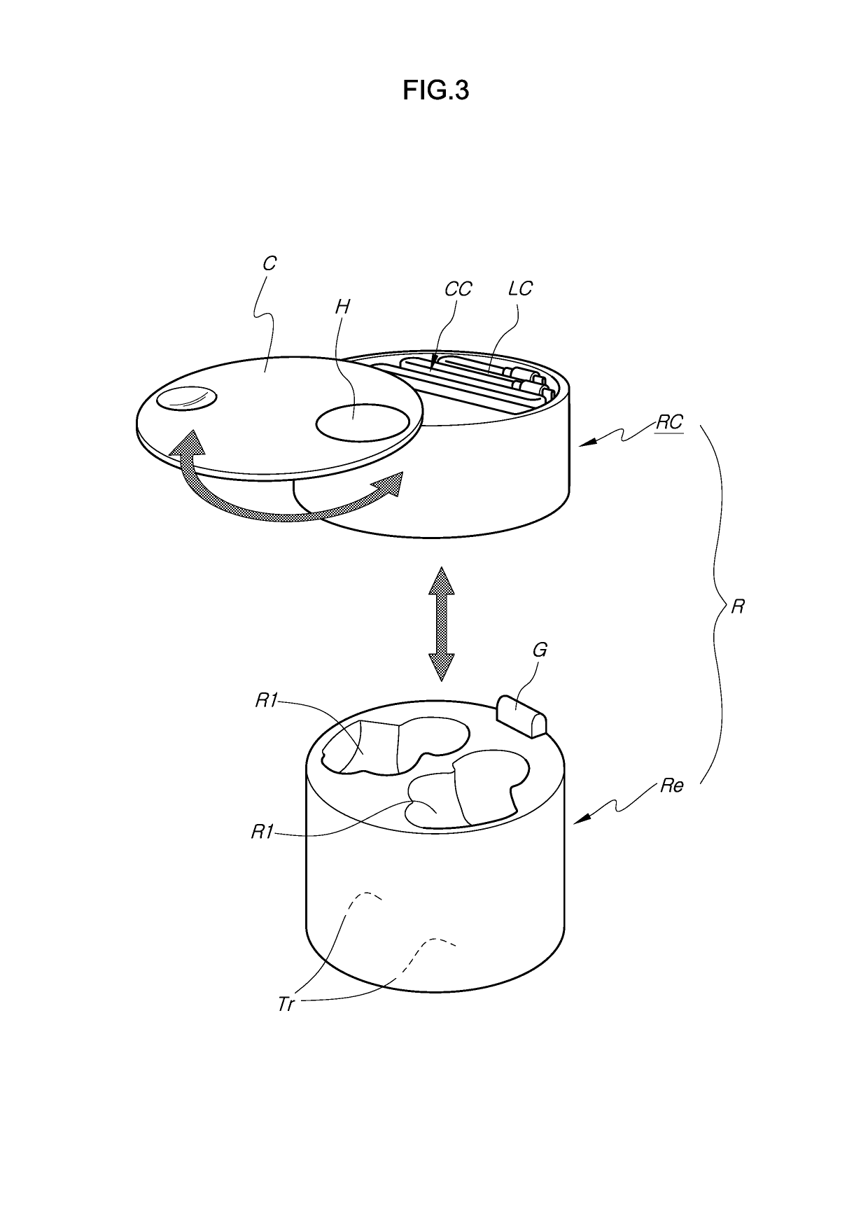

A charging terminal Tr as a terminal for grounding and voltage transmission at the end of a charging slot R1 of the charging cradle R shown in FIGS. 2 and 3 is provided as a terminal for connecting to the earphone terminal Te, and the above-described terminal connection configuration using a magnet attachment method is also preferable.

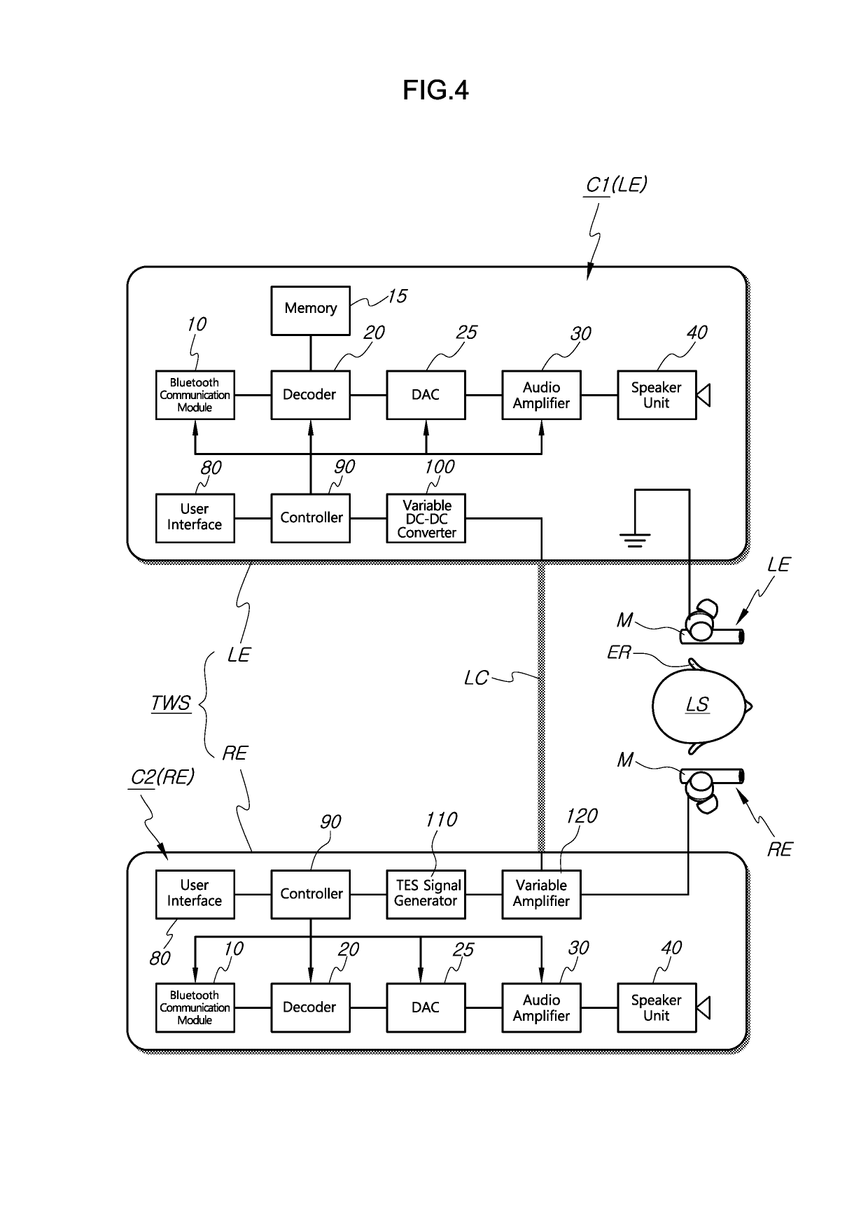

A description is made with reference to a circuit block diagram of FIG. 4.

The first circuit C1 of the board accommodated in one of the earphones RE and LE includes a Bluetooth communication module 10, memory 15, a decoder 20, a D/A converter 25, an audio amplifier 30, a speaker 40, a controller 90, and a DC/DC converter 100 operated by a user LS interface 80.

The second circuit C2 of the board accommodated in the other of the earphones RE and LE includes a Bluetooth communication module 10, memory 15, a decoder 20, a D/A converter 25, an audio amplifier 30, a speaker 40, and a controller 90 operated via a user LS interface 80. A TES signal generator 110, which is a low-frequency generator for TES treatment and is connected to the controller 90, and a variable amplifier 120 for amplifying the TES signal are provided.

In the above, the DC/DC converter 100 connected to the controller 90 of the first circuit unit C1 is for voltage matching that equally boosts or lowers the intensity of TES signals applied to the electrode M of each of the left and right earphones RE and LE when the user LS manipulates the intensity of TES signals using the user LS interface 80, the TES signal generator 110 connected to the controller 90 of the second circuit C2 generates TES signals to be applied to the user LS, and the variable amplifier 120 amplifies these signals and transmits the signals to the earphone RE.

The variable amplifier 120 functions as a switchable component through the DC/DC converter 100 when the left and right earphones RE and LE are connected via the link cable LC to be described later and are in electrically connected state through the user’s LS body.

With this configuration, the TES signal generation means and TES signal intensity control means are distributed separately in the first circuit C1 and the second circuit C2 of respective earphones RE and LE, allowing the size of each of the earphones RE and LE to be minimized and the accommodated battery capacity to be maximized, thereby extending the device’s lifespan.

The TES signals generated by the earphone RE operates by passing through the user LS body via both ears, requiring electrical conduction. Therefore, the link cable LC is provided as a component of the assembly to serve as the conduction means.

The link cable LC is a flexible conductor and includes, at respective ends, cable terminals Tc that are respectively connected to the earphone terminals Te of the earphones RE and LE via magnetic attachment, enabling the link cable LC and the earphones RE and LE to conduct electricity. The magnetic force can be overcome, allowing the user LS to easily detach the link cable LC from the earphones RE and LE.

The link cable LC is electrically connected via the cable terminals Tc to apply output signals from the DC/DC converter 100 in the first circuit C1 and the variable amplifier 120 in the second circuit C2 to the earphones RE and LE of the user, thereby enabling electrical conduction through the body.

When the user LS is not using the TES treatment function, the link cable LC may be detached from the earphones RE and LE by overcoming the magnetic force and may accommodated in a cable accommodation compartment CC provided in the charging cradle R. Thus, the charging cradle may be configured to prevent the loss of the cable terminals Tc or may be provided as a separate pouch.

Charging terminals and Tr at the ends of charging slots R1 of the charging cradle R and charging terminals Tr, through which ground and voltage Vin are applied, are provided as terminals for connection to the earphone terminals Te, and a terminal configuration using a magnet attachment method is also preferable.

Each of the cable terminals Tc of the link cable LC and the charging terminals Tr of the charging cradle R has a contact pin tp protruding from the center and activated by an inner spring (not illustrated) to connect with the earphone terminal Te of a corresponding one of the earphones RE and LE, and a ring-shaped contact piece tr that is electrically separated from the contact pin P, thereby performing current conduction (since the charge terminals Tr have the same configuration as the earphone terminals, the terminal configuration of the charge terminals Tr are not shown in the drawing).

The operation of the TWS earphone assembly having the TES treatment function with the above-described configuration according to the present disclosure is described.

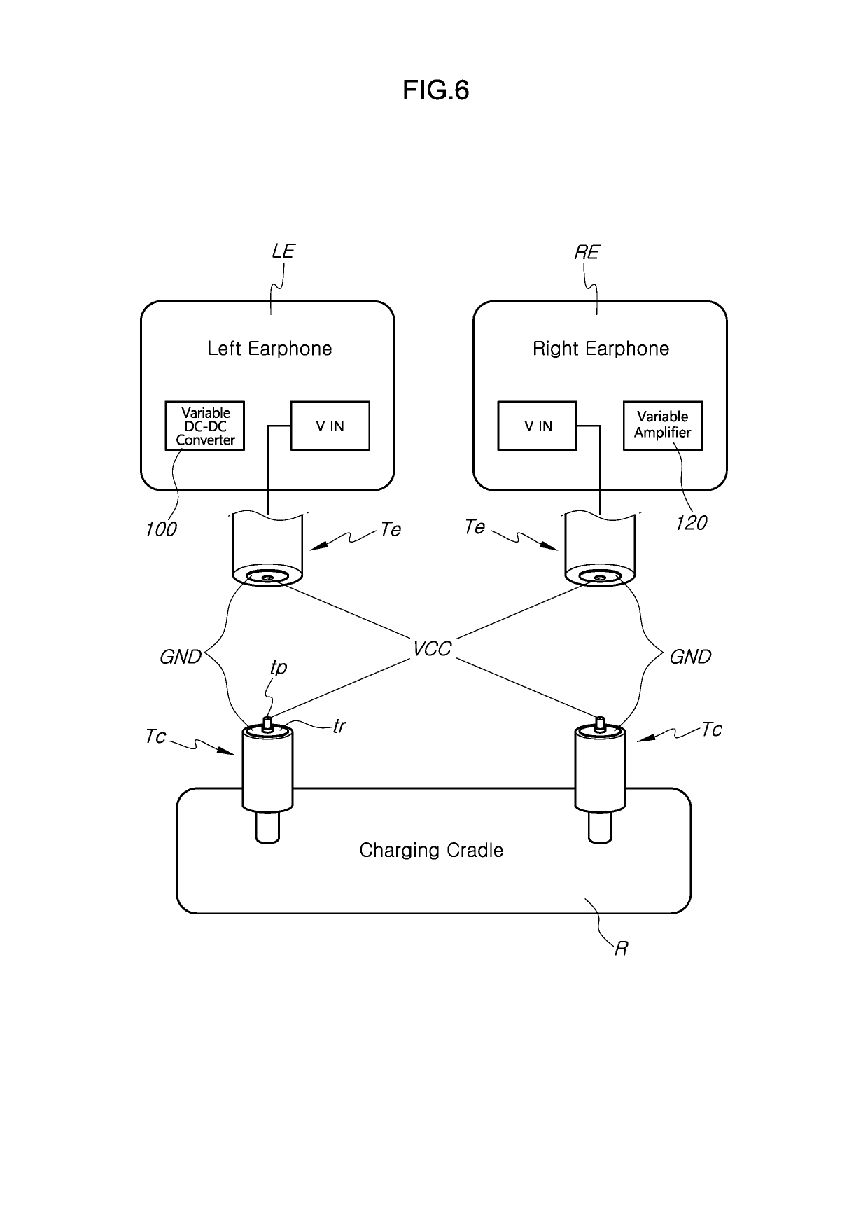

(1) When the user LS does not use the earphones RE and LE of the present disclosure and stores them in the charging slots R1 of the charging cradle R, the charging terminals Tr below the charging slots R1 and the earphone terminals Te of the earphones RE and LE are connected to enter the charging standby mode in which the voltage Vin of the batteries (not shown) is charged via the connected terminals, and in this state, the TES treatment function of the earphones RE and LE is not activated due to the absence of the link cable LC (see FIG. 6).

(2) When the user LS performs ordinary sound listening, the link cable LC is stored in the cable accommodation space CC of the charging cradle R and the earphones RE and LE are operated (if a function is provided to the earphones) in an ordinary sound listening routine or operated through the user interface 80.

(3) When the user LS wishes to use only the TES treatment function, or wishes to listen to healing music while simultaneously using the TES treatment function, the link cable LC is removed from the cable accommodation space CC and attached to the earphone terminals Te of the left and right earphones RE and LE with magnets, and an electrical connection is made between the terminals.

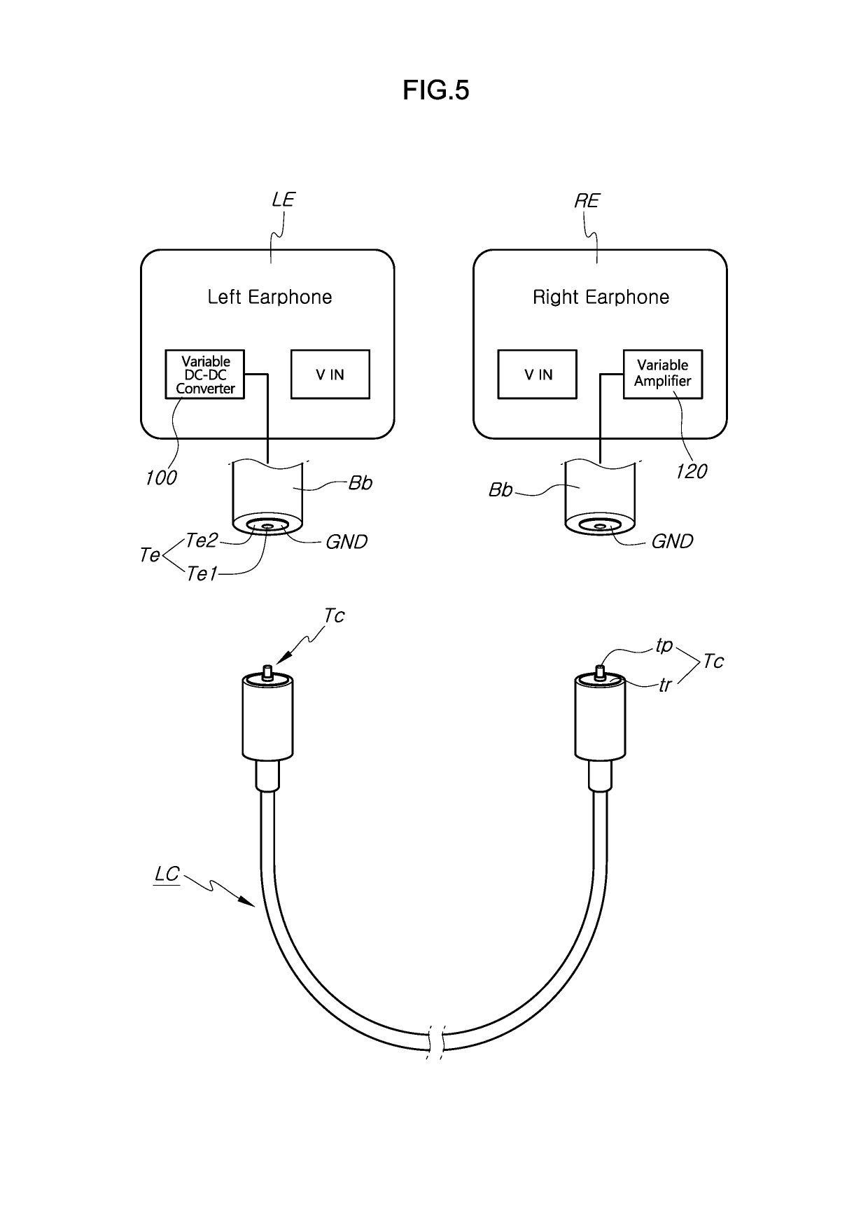

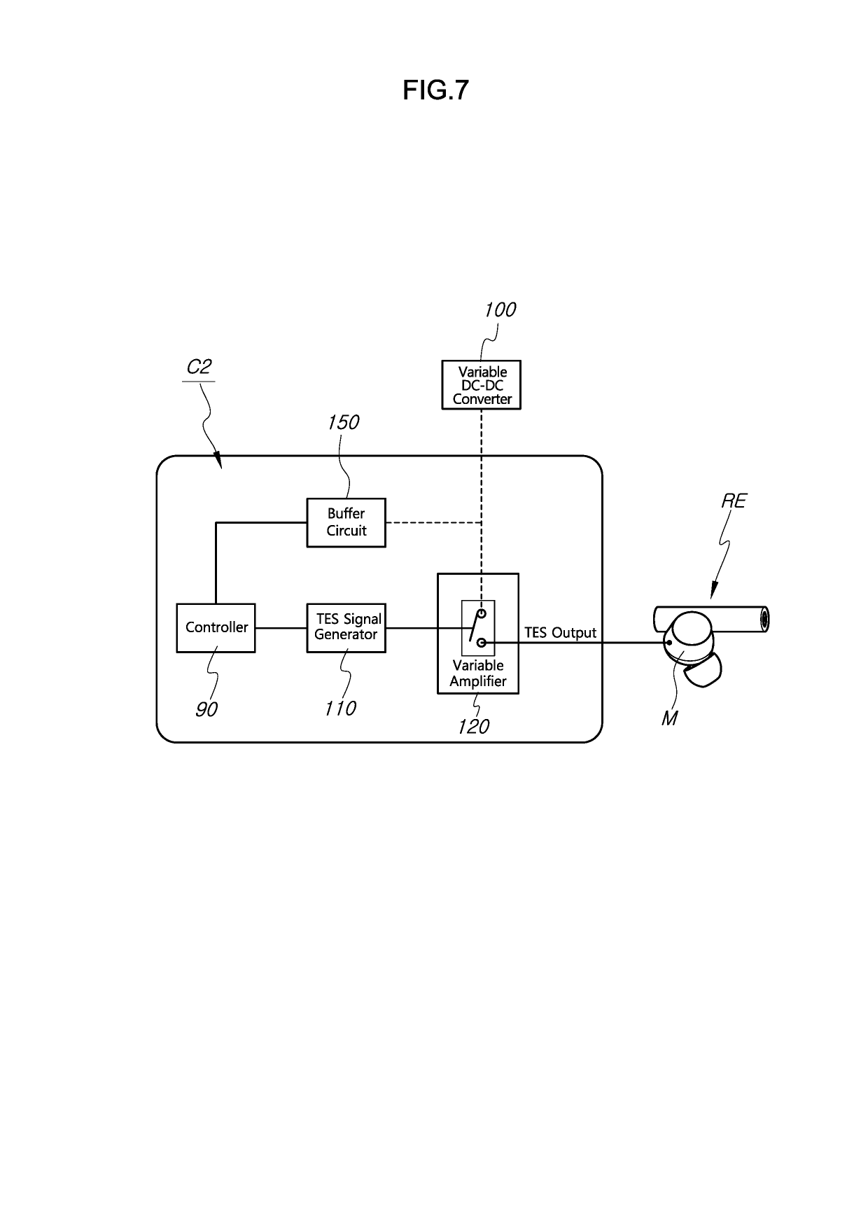

Then, TES signals from the variable amplifier 120, which amplifies the TES signals from the TES signal generator 110 of the second circuit C2 of one of the earphones RE and LE selected by the user LS interface 80 are applied to one ear of the user LS to be energized, and the TES signals are electrically connected to the DC/DC converter 100 of the first circuit C1 of another one of the earphones RE and LE and transmitted through both ears of the user LS, thereby allowing low frequency waves are applied to the user’s body, thereby executing the treatment function (see FIGS. 5 and 7: In FIG. 7, a buffer circuit 150 is provided to prevent damage to the circuit when the voltage level of the TES signals is higher than the voltage set by the controller 90).

(4) When the user LS adjusts the intensity of the TES signals using the user LS interface 80, the DC/DC converter 100 of the first circuit unit C1 matches the intensity of the TES signals with the intensity of the TES signals of the second circuit C2 based on the signals adjusted by the controller 90 of the second circuit C2, thereby controlling the intensities of the signals applied to both ears to be the same (see FIG. 7).

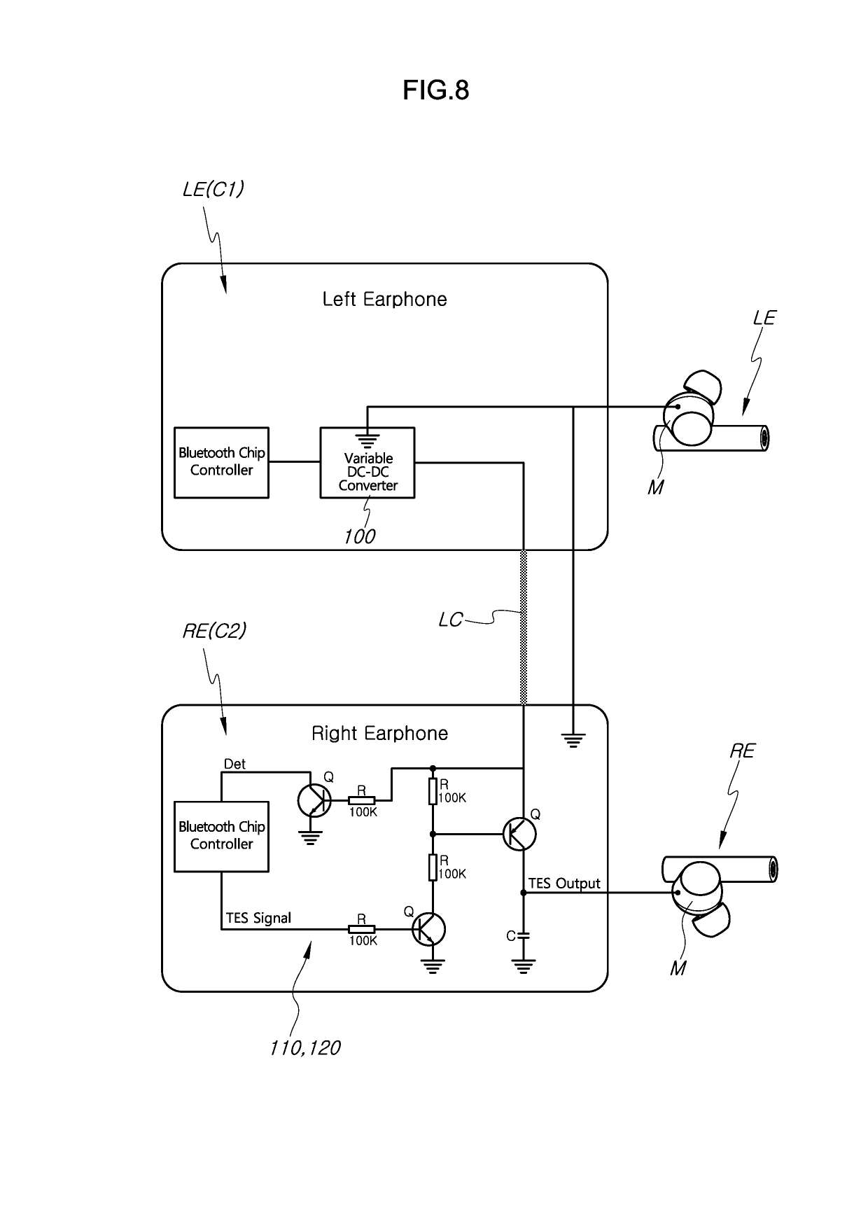

FIG. 8 shows the actual circuit configuration of a TWS earphone assembly A having a TES treatment function according to the present disclosure.

The Bluetooth communication module 10, the memory 15, the decoder 20, the D/A converter 25, and the audio amplifier 30 of each of the first circuit C1 and the second circuit C2 may be integrated into a single chip, and the TES signal generator 110 and variable amplifier 120 may be configured as an analog circuit.

The configuration and operation of the present disclosure will be described in more detail below.

The second circuit C2, which is a separated circuit of another one of the pair of earphones RE and LE separated into left and right, has a TES signal generator 50, which generates low-frequency waves for TES treatment and is connected to the controller 90 and the variable amplifier 60 to amplify the low-frequency signals, and the output of the variable amplifier will be determined by the voltage of the first circuit C1.

FIG. 7 shows how a TES signal voltage (intensity) is output variably, in which the variable amplifier 120 switches the voltage of the variable DC/DC converter 100 to ON/OFF and outputs it variably by user operation.

Depending on the user operation, the output voltage of the TES signals is determined according to the voltage of the variable DC/DC converter 100. For example, if the voltage of the variable DC/DC converter 100 is 4 V, the voltage level of the TES signals becomes 4 V, and the voltage of the variable DC/DC converter 100, the voltage level of the TES treatment signals becomes 20 V.

The reason why the TES signals should be output in a variable manner is that when the TES signals are applied to the user LS body (inner ear), the intensity of the electrical stimulation felt by each person is different, and the electrical stimulation actually felt by the user LS is different depending on the condition of the body at the time of use (factors such as the conditions of the skin that the electrode covers, the moisture condition, and the degree of adhesion to the skin).

Therefore, at the minimum level stage, the output voltage of TES signals may be set to a very small level that hardly anyone can feel the stimulation, and conversely, at the maximum level stage, the output voltage of TES signals may be set to a voltage level that statistically everyone can feel the stimulation, and it is desirable to set the voltage values between the voltage levels to specific steps (10 steps (Levels 1 to 10) and then evenly distribute the output interval values of the TES signals between respective levels.

When the link cable LC is disconnected from the earphones RE and LE, the earphones RE and LE are used only for the purpose of listening to sound, and in order to use the treatment function (therapy mode) by TES signals by electrically connecting the pair of left and right earphones RE and LE by attaching the link cable LC, means for determining whether the link cable LC is connected between the left and right earphones RE and LE is required.

This is because if the TES signal generator 110 and the variable DC/DC converter 100 operate while the left and right earphones RE and LE are separated, unnecessary current consumption will naturally occur, shortening the usage time of the built-in batteries of the earphones RE and LE.

FIGS. 7 and 8 are block diagrams showing the operation of detecting whether the left and right earphones RE and LE are connected via the link cable LC.

The buffer circuit 150 serves to prevent damage to the entire circuit due to high voltage of the variable DC/DC converter 100.

In FIG. 8, a Det port from the Bluetooth communication module 10 is configured to be LOW when the electric voltage of the variable DC/DC converter 100 is output (i.e., when the link cable LC is connected to the earphones RE and LE), and to be in a mode for listening only when no voltage is applied (i.e., when the link cable (LC) is disconnected from the earphones RE and LE), so that the connection status of the left and right earphones RE and LE can be determined. In addition, even if the output voltage from the variable DC/D converter 100 is very high, it is protected by the circuit protection function of transistors Q.

Although not a major technical aspect of the present disclosure, the charging cradle R as a corresponding component of the earphone assembly A of the present disclosure is described in detail with reference to FIGS. 2 and 3.

Although various shapes and configurations may be adopted, the interior of the charging cradle R is divided into separated upper and lower spaces, i.e., a cable storage section Rc that has a cable accommodation space CC, which is a recessed portion for accommodating the link cable LC, and an earphone charging section Re that has a pair of elongated slit-shaped charging slots R1 that stores earphones RE and LE, and charging terminals Tr are provided at the lower portion of the earphone charging section.

It is preferable from the viewpoints of convenience of storage and portability to provide a cover plate C independent of the cable storage section Rc so that the cable storage section Rc and the cover plate C are axially connected at a hinge axis H so that the cover plate C can be opened or closed by rotating it relative to the cable storage section Rc.

The cable storage section Rc and the earphone charging section Re may be formed as separate cylindrical bodies and stacked on each other using a joining guide G, as shown, or may be formed as a pouch and a charging cradle having a cable storage section Rc as a separate storage pocket (not shown).

What is claimed is:

1. A TWS earphone assembly (A) comprising:
an electrode (M) for electrical connection with a skin of an ear of a user on an outer surface of an ear unit (I) of each of a pair of electrically separated left and right earphones (RE, LE);
a circuit accommodated in each of the earphones (RE, LE) and having a Bluetooth communication module (10), memory (15), a decoder (20), a D/A converter (25), an audio amplifier (30), a speaker (40), and a controller (90) controlled via a user (LS) interface (80);
a charging cradle (R) having terminals connected to terminals of the earphones (RE, LE) to enable charging of the earphones (RE, LE),
a variable DC/DC converter (100), which is provided in a first circuit (C1), which is a separated circuit of one of the pair of separated left and right earphones (RE, LE), and connected to the control part (90);
a TES signal generator (50), which generates low-frequency signals for treatment, and a variable amplifier (60) configured to amplify the low-frequency signals, wherein the TES signal generator and the variable amplifier are provided in a second circuit (C2), which is another one of separated circuits of the pair of separated right and left earphones and connected to the controller (90); and
a link cable (LC), which is selectively attached to/detached from terminals of the pair of left and right earphones (RE, LE) to electrically connect or disconnect the earphones (RE, LE),
wherein the TWS earphone assembly is configured to selectively perform sound playback function as TWS earphones and TES treatment function individually or simultaneously,
wherein the sound playback function is executed when the pair of left and right earphones (RE, LE) are used in a state where the link cable (LC) is detached therefrom, and
wherein the TES treatment function is executed by allowing the low-frequency signals flow between the electrodes (M) of the earphones (RE, LE) through the body of the user (LS) in a state where the terminals of the pair of earphones (RE, LE) and the link cable (LC) are attached to the earphones.

2. The TWS earphone assembly of claim 1, wherein a charging mode and a use mode is switched by selectively performing a connection the terminals of the earphones (RE, LE) to the terminals of the link cable (LC) and a connection the terminals of the earphone (RE, LE) to the terminals of the charging cradle (R).

3. The TWS earphone assembly of claim 1, wherein, when the user (LS) performs ordinary sound listening,
the link cable (LC) is stored in the cable accommodation space (CC) of the charging cradle (R) to be used for sound listening, and
wherein, when the user (LS) uses the TES treatment function alone or together with sound listening,
the terminals of the link cable (LC) are connected to terminals of the earphones (RE, LE), and the TES signals from the variable amplifier (120), which amplifies the TES signals from the TES signal generator (110) of the second circuit (C2) of the earphones (RE, LE), are applied to one ear of the user LS for electrical connection, and
the variable amplifier is electrically connected to the DC/DC converter (100) of the first circuit (C1) of another one of the earphones (RE, LE), and the TES signals are applied to both ears of the user (LS) and low-frequency signals are applied to the user’s body.

4. The TWS earphone assembly of claim 1, wherein electrical connection of the first circuit (C1), the second circuit (C2), and the link cable (LC) accommodated in the body housings (B) of the pair of left and right earphones (RE, LE) is turned on/off by connecting and disconnecting the electrode bodies of the terminals using magnets.

5. The TWS earphone assembly of claim 1, wherein the charging cradle (R) comprises:
a cable storage unit (Rc) having a cable storage space (CC) configured to store the link cable (LC); and
an earphone charging unit (Re) in which charging slots (R1) configured to accommodate the earphones (RE, LE) are provided in a slit shape and charging terminals (Tr) are provided in lower portions of the charging slots, and
wherein the earphone charging unit (Re) and the cable storage unit (Rc) are provided separately from each other or are integrally stacked to form a single assembly.

6. The TWS earphone assembly of claim 1, further comprising:
a buffer circuit (150) configured to prevent circuit damage when the voltage level of the TES signals is higher than a voltage set by the controller (90) between the variable amplifier (60) connected to the controller (90) of the first circuit (C1) and the variable amplifier (60) configured to amplify the low-frequency signals, and the DC/DC converter (100) connected to the controller (90) of the second circuit (C2).
